(19) United States
(12) Patent Application Publication
(10) Pub. No.: US 2013/0181839 A1
(43) Pub. Date: Jul. 18, 2013

(54) Method and Apparatus for Energy Efficient and Low Maintenance Cost Wireless Monitoring of Physical Items and Animals from the Internet

(71) Applicant: Zhiheng Cao, Irvine, CA (US)

(72) Inventor: Zhiheng Cao, Irvine, CA (US)

(73) Assignee: Zhiheng Cao, Irvine, CA (US)

(21) Appl. No.: 13/349,521

(22) Filed: Jan. 12, 2012

(51) Int. Cl. G08B 13/14

(52) U.S. Cl. 340/572.1

(57) ABSTRACT

Method and an apparatus for giving notifications such as sound, ring-tone, vibration, e-mails, text messages, or phone calls to users when a physical item such as doors, gates, windows, cars, or household items have been moved from its original location, or has its orientation changed, comprising a tag manager connected to the Internet, and one or more sensor tags coupled to the tag manager through wireless connection. Notifications may also be given when the physical item has returned to its original orientation. Notifications may also be given when communication link is disrupted. Methods are provided to reduce power consumption of each sensor tag sufficiently to allow powered solely from an energy harvesting unit, such as one comprising a solar panel, without requiring need of battery maintenance. The users may configure and control the tag manager and each sensor tag, and issue commands to each sensor tag, from the Internet.

### CROSS-REFERENCE TO RELATED APPLICATIONS

Not applicable

### FEDERALLY SPONSORED RESEARCH

Not applicable

### SEQUENCE LISTING OR PROGRAM

Not applicable

### BACKGROUND OF THE INVENTION

1. Field of the Invention

This invention relates to electronics hardware and software system to allow users to monitor and receive notification from the Internet on movement or orientation change of physical items and animals, without connecting any signal or power wiring to the items and animals, in an energy efficient way and at very little or no maintenance cost.

2. Description of the Related Art

Various systems for locating lost or misplaced items have been proposed to date, such as those disclosed in U.S. Pat. Nos. 4,101,873, 4,476,469, 5,638,050, 5,939,981, 6,147,602, 6,462,658, 6,535,125, 6,674,364, 7,064,662, 7,551,076, 6,967,563 and 7,755,490. These systems typically comprise a radio wave transmitter tool carried by a user or fixed on a wall, and a radio wave receiving tag attached to items. When the user presses a button on the transmitter tool, an audible alarm on the tag sounds to allow the user to locate the lost or misplaced item. However, they do not allow user to receive notifications when the item has been physically moved. Because a special-purpose transmitter tool is required for the user to operate the system, the user must always carry such special device or be physically next to such device to utilize the system.

Various Internet-enabled home automation and security systems exist, such as Insteon. These systems allow the user to control lighting, or receive security camera images remotely from the Internet by using a Web browser. The systems can be operated from the Internet using a wide variety of general-purpose devices including PC, Mac or smart-phones, making them accessible anytime, anywhere. However, because each receiving unit must be wired to a power source to function, installation of such system is expensive and time consuming, and may even be impossible outdoors where power source is absent.

### BRIEF SUMMARY OF THE INVENTION

The present invention provides a method and an apparatus for giving notifications such as sound, ring-tone, vibration, e-mails, text messages, or phone calls to user when a physical item such as doors, gates, windows, cars, or household items, which may reside at a remote location, have been moved from its original location, or has its orientation changed. Notifications may also be given when the physical item has returned to its original orientation. Notifications may also be given when communication link is disrupted.

An embodiment of the present invention comprises a central wireless unit connected to the Internet, referred hereafter as “tag manager”; multiple battery powered wireless units with integrated sensors, referred hereafter as “sensor tags” and one or more servers connected to the Internet, referred hereafter as “Web Server” or “Chat Server”. Sensor tags may also include energy harvesting units such as photovoltaic (solar panels) or thermoelectric generators and a rechargeable battery. Each sensor tag includes necessary means, such as elastic band, Velcro tapes, key-rings, or glues for mounting to various items or animals. The tag manager communicates with Internet servers to upload events received from each sensor tags and receive command issued by the user and transmit wirelessly to applicable sensor tags.

The present invention provides a method and an apparatus to reduce the power consumption of each sensor tag such that they can be powered by a single coin cell battery without need of replacement for a year or more. Such low power consumption also allows each sensor tag to be powered solely from a small solar panel (or other energy harvesting means) coupled with a small capacity (3 mAh for example) rechargeable battery, such that the battery is charged during the day and allows the sensor to keep working throughout the night. This allows the system to be easily installed without any wiring to a wide variety of items, indoors or outdoors, while requiring minimal to no maintenance (such as battery replacement). Each sensor tag may include an audible buzzer, which may be triggered by a user command from the Internet to emit beeping sound. This allows user to easily locate each sensor tag around the user within the audible distance by tracing back to the source of a beeping sound.

Each sensor tag in an embodiment includes a battery, a radio frequency (RF) transceiver, a microcontroller, flash memory, a digital 3-axes (3-dimensional) magnetic sensor (compass), and/or a 3-axes (3-dimensional) accelerometer, and optionally one or more audible signal generator such as a piezo buzzer. The microcontroller and/or RF transceiver include power saving circuitry and control methods to reduce the power consumption needed to maintain communication link with the tag manager. The control methods allow reporting remaining battery life (which may be detected by current battery voltage) back to the tag manager. This provides centralized monitoring of multiple sensor tags and identification of those sensor tags requiring maintenance.

### BRIEF DESCRIPTION OF THE SEVERAL VIEWS OF THE DRAWING

The invention can be better understood with reference to the following detailed description together with the appended drawings in which like elements are numbered the same:

FIG. 1 depicts a functional view of a preferred embodiment of the present invention;

FIG. 2 depicts a functional view of a preferred embodiment of a sensor tag of the present invention;

FIG. 3 depicts a functional view of a preferred embodiment of a tag manager of the present invention;

FIG. 4 depicts a preferred steady state control flow chart used by the embodiment of a tag manager shown in FIG. 3;

FIG. 5 depicts a preferred control flow chart used by the embodiment of a sensor tag shown in FIG. 2;

FIG. 6 depicts a timing diagram of the present invention during a wireless communication between a tag manager and multiple sensor tags;

FIG. 7 depicts a preferred control flow chart used by the embodiment of a sensor tag shown in FIG. 2, with more details about steps 514, 515 and 516;

FIG. 8 depicts a preferred control flow chart used by the embodiment of a sensor tag shown in FIG. 2, with more details about steps 511;

FIG. 9 depicts a preferred control flow chart used by the embodiment of a tag manager shown in FIG. 3, illustrating in more detail the initial start-up sequence and the interaction among the tag manager, the Web Server and the Chat Server; and

FIG. 10 shows a table illustrating operation performed by the Web Server.

### DETAILED DESCRIPTION OF THE INVENTION

### Construction

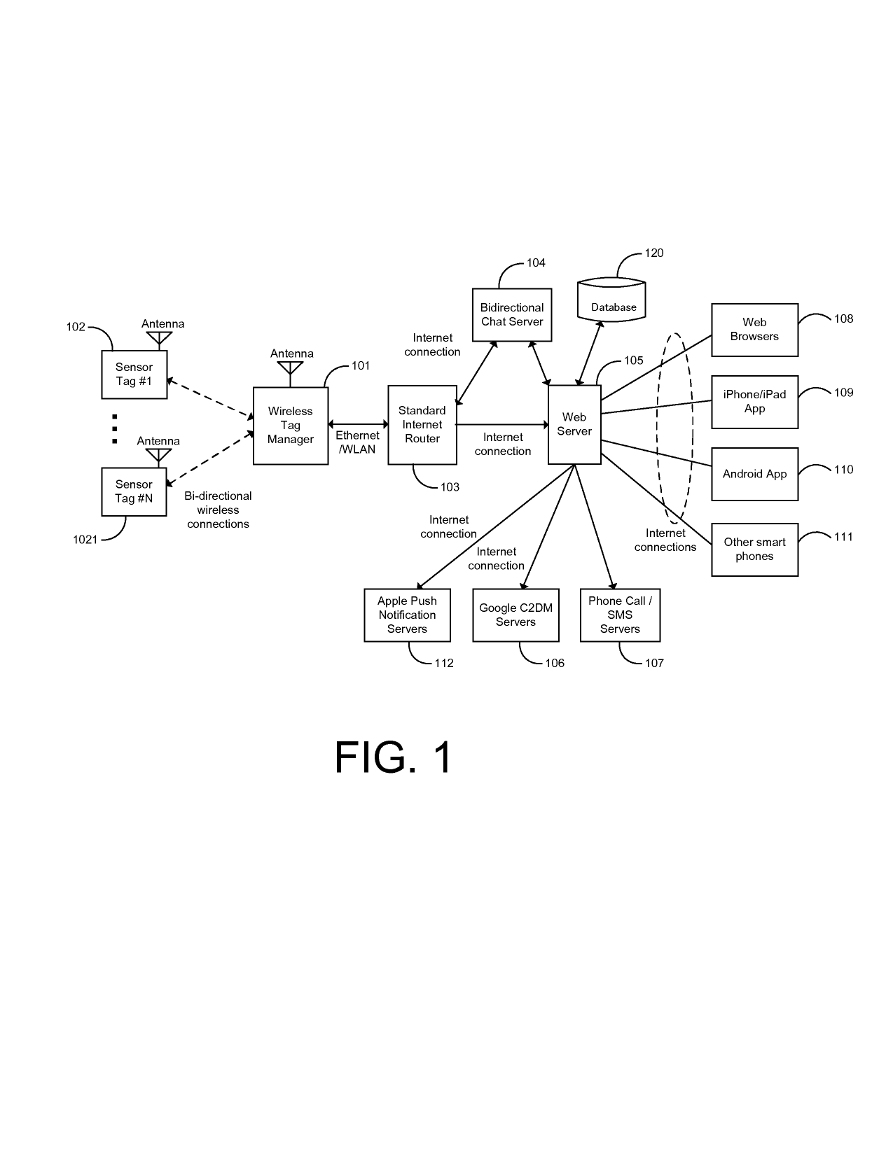

FIG. 1 shows a system-level block diagram of a preferred embodiment of the present invention including multiple sensor tags 102, 1021, a tag manager 101, an Internet router 103, which preferably is a standard, general purpose router such as Linksys E1000. 101, 102 and 103 typically reside in customer premise such as a house, a store, a warehouse, or a farm. The router 103 is connected through the Internet to one or more bi-directional Chat Servers 104, preferably running a standard based IRC (Internet Relay Chat) Chat Server program. 105 represents one or more Web server(s), preferably running a standard based HTTP server such as Microsoft IIS (Internet Information Server), which are also connected through internet to router 103. Servers 104 and 105 may reside on the same computers or on separate computers that are connected through the Internet. In place of a Chat Server 104, other means to achieve bi-directional communication between the tag manager 101 and Web Server 105 may also be used. For example, a Web Socket, or a “long-poll” technique may be used for the tag manager to receive commands from the Web Server 105, instead of through a Chat Server 104 as chat messages sent by Web Server 105. If these techniques are used, Chat Server 104 is not necessary.

A relational database 120, preferably implemented using Microsoft SQL Server 2008, is available for access from each of the Web Server 105. Client devices such as web browsers 108, iPhone or iPad devices running custom App 109, Android devices running a custom App 110, or other types of smart phones 111 need only be able to access web services provided by Web Server 105 through the Internet. Web Server 105 may optionally connect through internet to an Apple Push Notification Server 112 to send notification messages to iPhone or iPad Apps 109, to a Google C2DM (Cloud to Device Messaging) server 106 to send messages to Android devices 110, or to various types of servers 107 designed to make phone calls or send text messages.

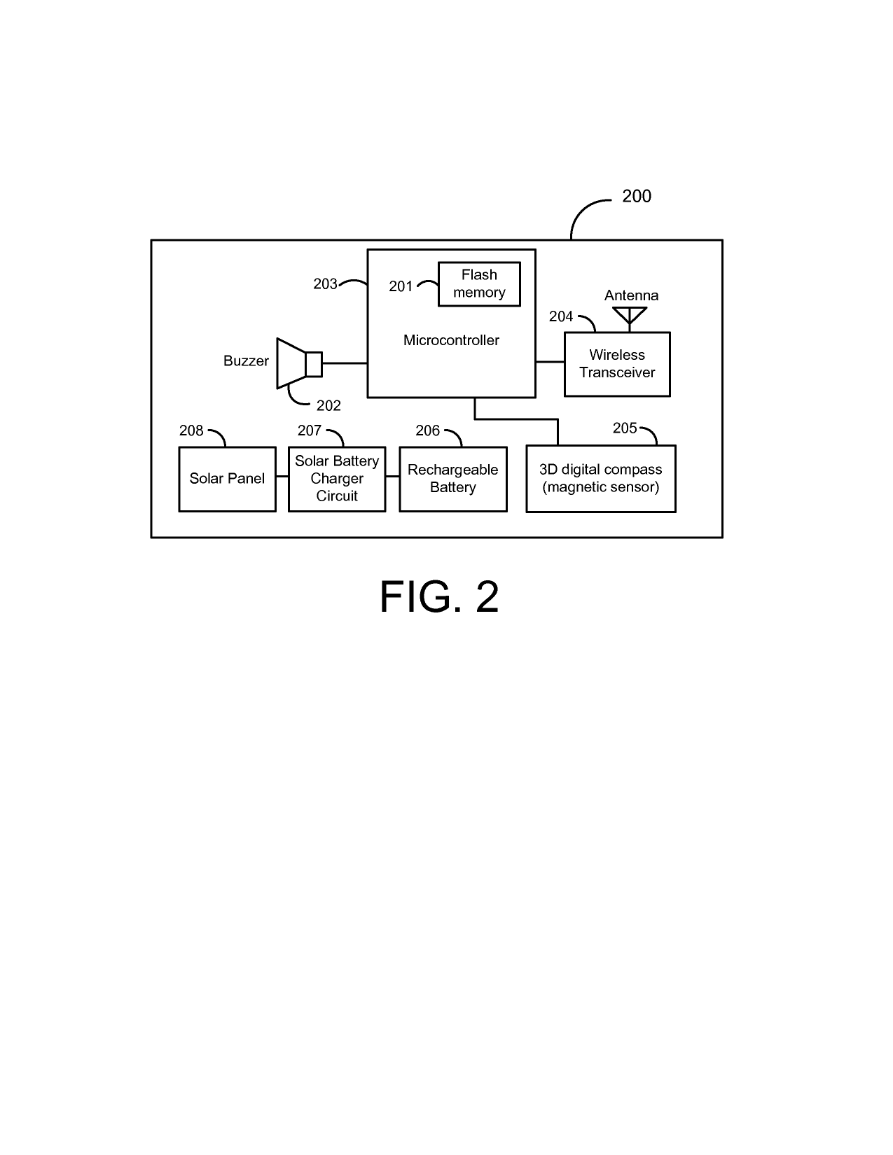

Now referring to FIG. 2, which shows a preferred embodiment of a sensor tag 200. A control circuit 203 is preferably implemented using widely available general purpose microcontroller integrated circuits (IC) such as part number PIC16F720 from Microchip. The control circuit 203 preferably includes a flash memory device 201 to store identification (ID) information unique to each sensor tag, and control flows disclosed in the present invention in the form of a firmware program. Other types of microcontroller IC may also be used for control circuit 203 and ID information can be stored using jumper switches or stored in Random Access Memory (RAM) found in most microcontroller ICs.

A wireless transceiver 204 is preferably implemented by using a 433 MHz band RF transmitter IC typically found in garage openers such as part number MRF47XA from Microchip, together with conventional necessary external components such as a crystal, a power supply, capacitors (not shown in figure). The transceiver 204 is coupled to control circuit 203 on a printed circuit board preferably using a serial communication standard such as SPI or I2C. Alternatively control circuit 203 and transceiver 204 may be combined inside a single chip such as part number Si1020 also from Silicon Laboratories.

A digital magnetic sensor 205, preferably 3-axis or 3D digital compass IC part number HMC5883L available from Honeywell, is coupled to control circuit 203 preferably using a serial communication standard such as SPI or I2C. Also, preferably the power supply of sensor 205 is also connected to an I/O pin of control circuit 203. This allows control circuit 203 to turn on sensor 205 periodically for a short amount of time to take a measurement of 3D vector of the magnetic field of the Earth with respect to the orientation of the sensor tag 200 on which the sensor 205 is permanently attached. This also allows control circuit 203 to completely turn off sensor 205 for the majority of the time to achieve low average power consumption. By recording this field vector at user specified interval, any slight orientation change resulted from the sensor tag 200 being touched/moved can be detected, while consuming very little power.

In place of a magnetic sensor, for applications where each sensor tag need only detect change of tilt angle instead of change of angle in all directions, 205 may also be replaced with an acceleration sensor (also called accelerometer) capable of measuring the gravitational pull of the Earth. The acceleration sensor may be controlled in the same manner to periodically measure the tilt angle and report any substantial difference from previous element to the tag manager.

An energy harvesting and storage circuit, preferably comprising a solar panel 208, coupled with a solar battery charger circuit 207 which preferably be a sophisticated integrated circuit such as part number SPV1040 from STMicroelectronics but can also be built with a few discrete transistors for low cost applications, and a small capacity rechargeable battery 206, such as part number MS614SE-FL28E from Seiko Instruments, is integrated onto sensor tag 200. The charger circuit 207 provides necessary power supply for control circuit 203, transceiver 204, magnetic sensor 205, and other electronics on the sensor tag 200. The charger circuit 207 charges battery 206 whenever solar panel 208 can generate sufficient energy. Energy stored on battery 206 is automatically used to supplement power to electronics on sensor tag 200 when solar energy alone is insufficient. Instead of unit comprising 206, 207 and 208 described above, other forms of energy harvesting units may also be used, or a battery may be used instead. In the latter case, periodic replacement of the battery will be necessary, but thanks to methods disclosed in the present invention, the battery replacement interval may be configured to be sufficiently long, making the maintenance cost of each sensor tag negligible.

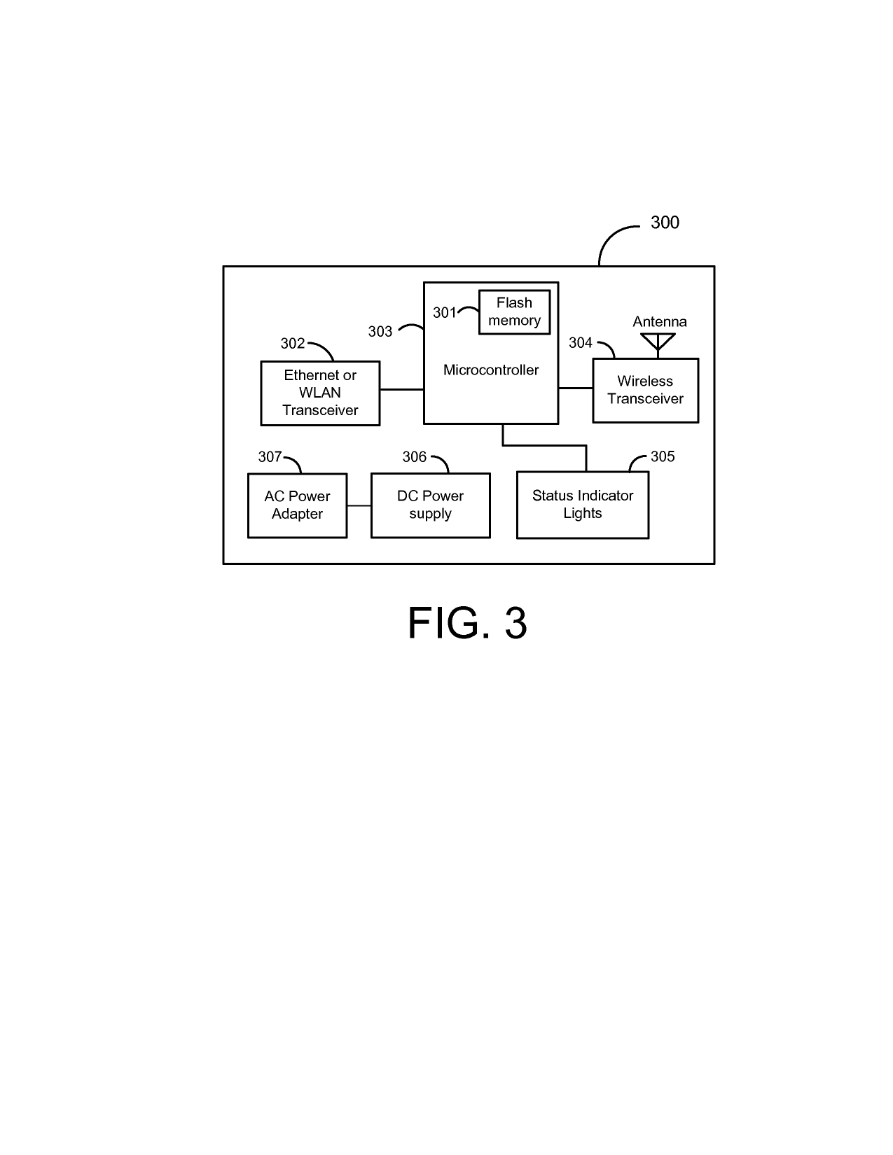

Now referring to FIG. 3, which shows a preferred embodiment of a tag manager 300. A control circuit 303 is preferably implemented using widely available general purpose microcontroller integrated circuits (IC). The control circuit 303 preferably includes a flash memory device 301 to store a serial number unique to each tag manager, Internet address of the Web Server 105, and control flows disclosed in the present invention in the form of a firmware program. An Ethernet transceiver 302, such as part number ENC28J60, is coupled to control circuit 303. Transceiver 302 and control circuit 303 may be integrated into a same IC, such as part number PIC18F67J60 from Microchip. Alternatively, a wireless-LAN transceiver may be used in place of Ethernet transceiver 302. A wireless transceiver 304 is preferably implemented by using a 433 MHz band RF transmitter IC such as part number MRF47XA from Microchip, together with conventional necessary external components such as a crystal, a power supply, capacitors (not shown in figure). The transceiver 304 is coupled to control circuit 303 on a printed circuit board preferably using a serial communication standard such as SPI or I2C. Control circuit 303 is further coupled with status indicator lights 305, preferably implemented as one or more of light emitting diodes (LEDs). The tag manager 300 is preferably powered by an external power source, such as wall plug or a USB cable. A DC power supply 306 may be included in the tag manager to supply power to electronic components inside the tag manager 300 and an AC power adapter 307 may be used to convert wall plug AC down to DC voltage needed by 306.

### Operation

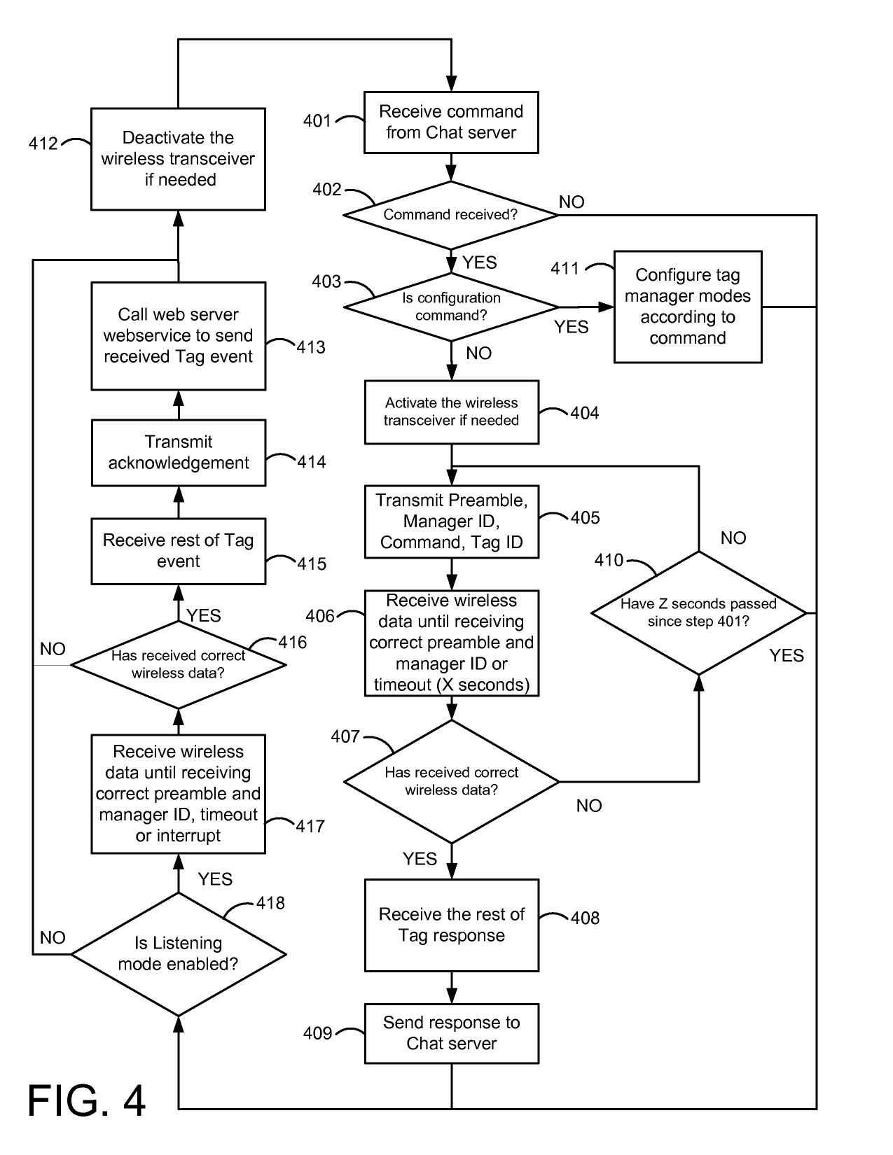

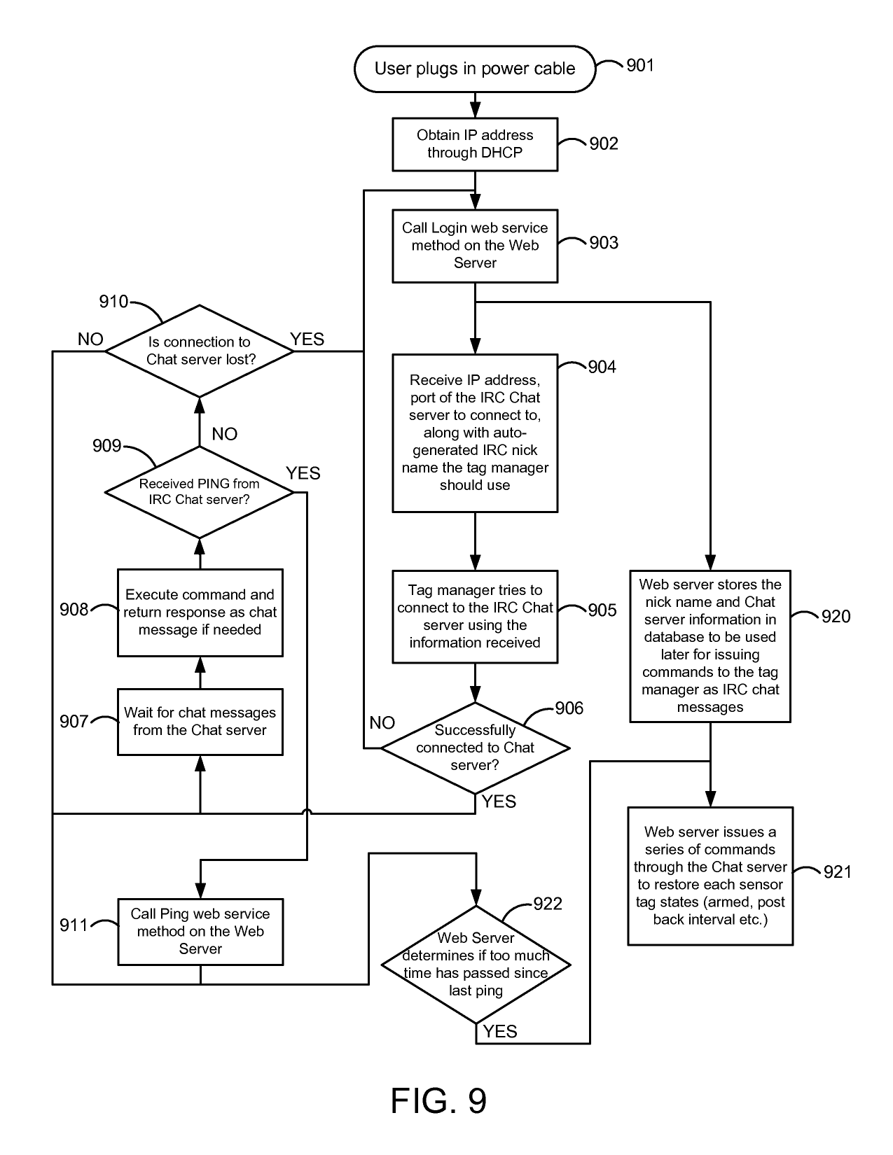

FIG. 4 depicts a preferred control flow chart used by the embodiment of a tag manager shown in FIG. 3, in a steady state loop, after an initial start-up sequence. The start-up sequence is described later in association with FIG. 9. This control flow can be implemented as a firmware program, a software program, or as digital hardware using finite state machine. In step 401, the control circuit 303 tries to receive a command from the Chat Server 104 in the form of a chat message sent by Web Server 105. If the command is received in step 402, in step 403 the command is decoded and checked if it is a configuration command or a command requiring wireless transmission. If the command is not received, steps 403 to 409 are skipped immediately and step 417 is executed if in “Listening mode”. This ensures that when not executing any command, tag manager will for the majority of the time be in a state ready to receive events from each sensor tag 102. If a configuration command is received, the tag manager updates its internal states (for example, setting “Listening mode” flag.) If received command is not a configuration command but rather a command targeting one or multiple sensor tags, in step 404 wireless transceiver 304 is activated as needed, and in step 405, a sequence of data comprising a preamble, a tag manager ID, a command ID, and target sensor tag ID is transmitted by transceiver 304. Immediately in the following step 406, transceiver 304 switches to receive mode and tries to receive a response for a short period of time (X seconds). The timeout value X should be chosen just enough to receive a preamble and a tag manager ID. This allows the tag manager to repeat transmission in step 405 as frequently as possible, and hence to increase the chance the transmission be received by a sensor tag. If in the following step 407, the beginning of a correct sensor tag response comprising a correct preamble and a matching tag manager ID is not received, steps 405 and 406 are repeated until Z second (user configured command timeout) has passed, which is checked in step 410. If in step 407 the beginning of a correct sensor tag response is received, remaining part of the tag response is received in step 408. In the following step 409, the tag response is translated to a chat message to be received by Web server 105.

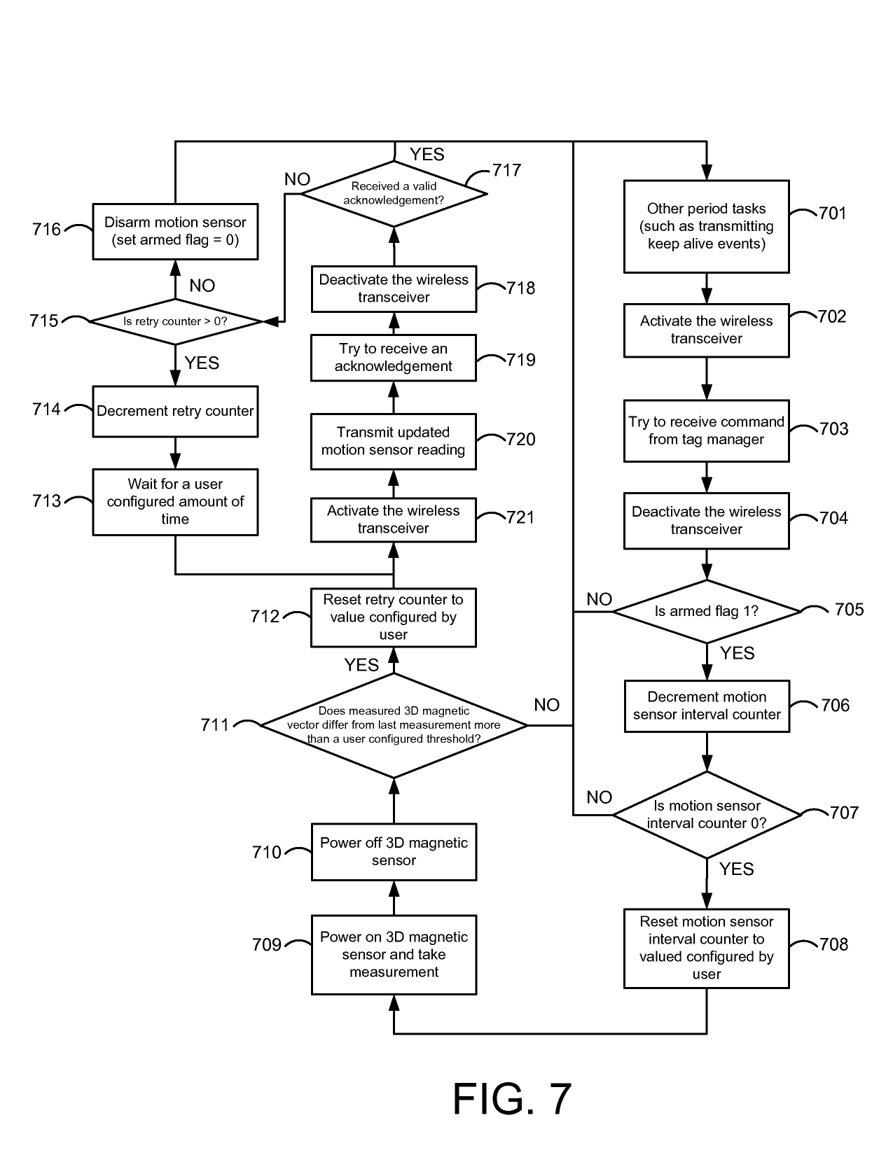

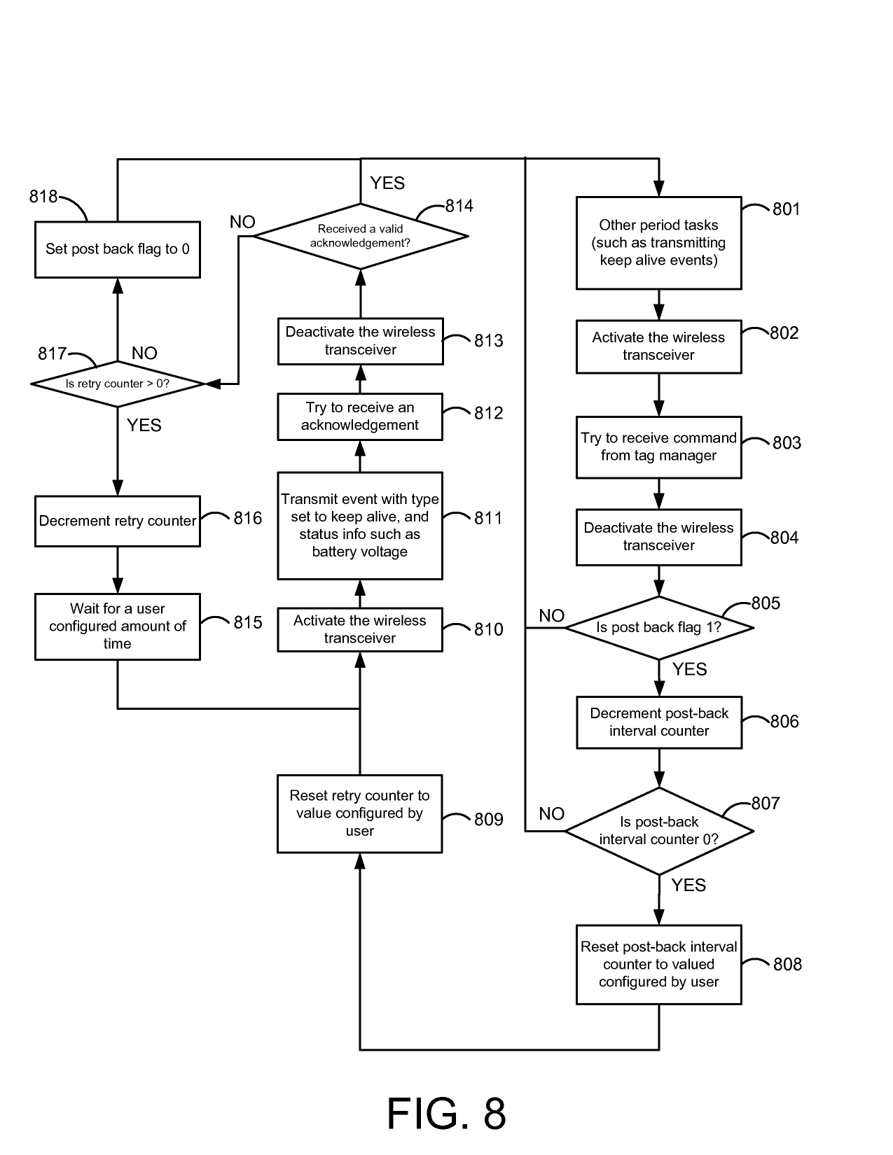

In step 418, if the tag manager is not configured to “Listening mode”, for example when none of the sensor tag is armed, then the control circuit transitions to step 412 to turn off transceiver if needed and starts receiving the next command in step 401. This maximizes responsiveness of the tag manager to any user command issued to the Web Server 105, which translate the command and send to the Chat Server 104. If the tag manager is configured to “Listening mode”, in step 417 the tag manager will try to receive any wireless messages from a sensor tag by putting the transceiver 304 in receive mode. In a simple embodiment, a timeout value may be chosen for example at 0.5 second, such that there is a maximum 0.5 second delay in responding to user command, but long enough time to ensure that for the majority of time the tag manager is ready to receive any sensor tag transmission of events. Even when any sensor tag transmit at a time when the tag manager happens to be not receiving, automatic re-transmission described later in association with FIG. 7 and FIG. 8, allows reliable transmission of sensor tag events to the tag manager. Alternatively, in a more sophisticated embodiment, receive step 417 may continue for a longer period of time, but be terminated by a Receive Packet Pending Interrupt (or equivalent interrupt) from the Ethernet/WLAN transceiver 302, such that the tag manager can immediately respond to any incoming command from the Internet.

In step 416, if a correct preamble and matching tag manager ID is found in messages received in step 417, the remaining part of the wireless packet is received in step 415. If timeout or an Ethernet/WLAN interrupt occurs, steps 413 to 415 are skipped. In step 414, the tag manager immediately transmits an acknowledgement wireless message using wireless transceiver 304. In the following step 413, received data in steps 415 and 417 are sent to Web server 105 preferably in the form of a web service call. In step 412 the transceiver 304 is powered off if not in Listening mode, or already powered off.

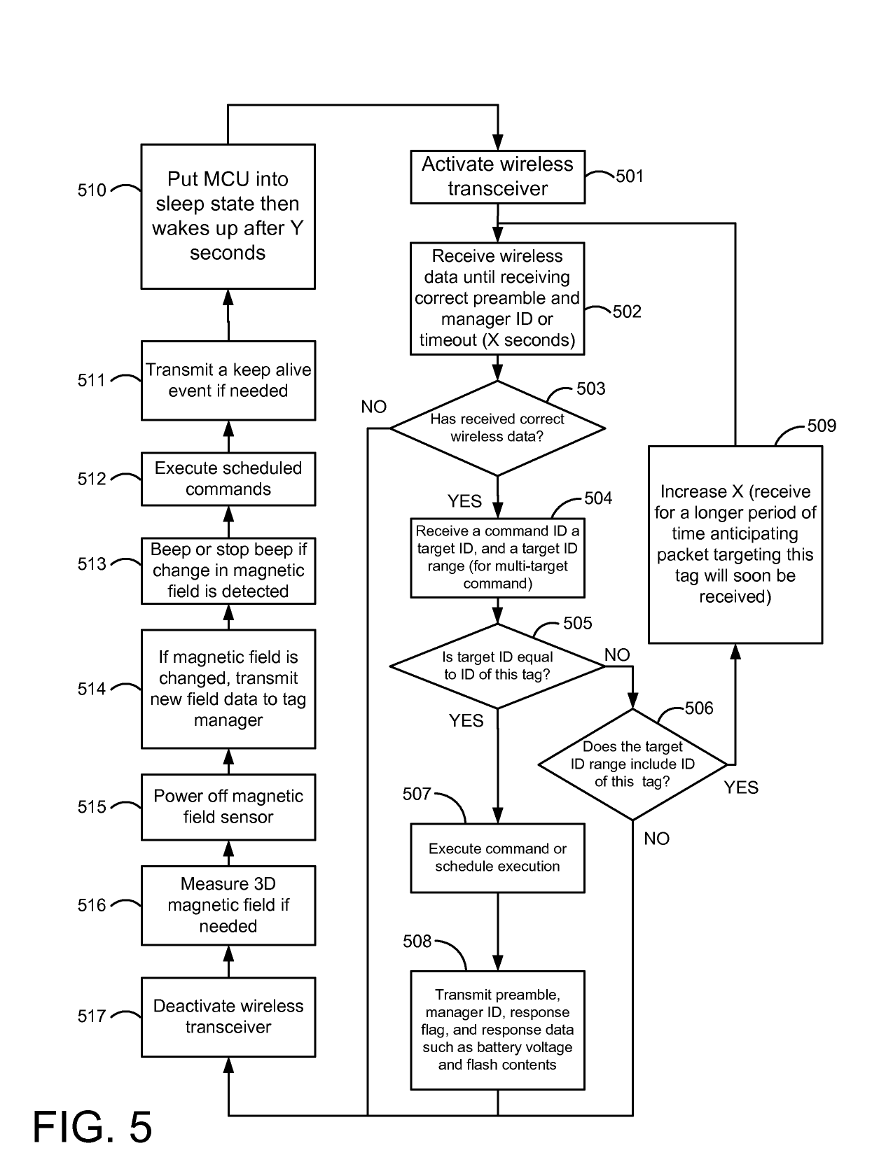

FIG. 5 depicts a control flow used by the embodiment of a sensor tag shown in FIG. 2, in a steady state loop after powering up and a conventional initialization sequence. This control flow can be implemented as a firmware program or as digital hardware using a finite state machine. In step 501, the control circuit 203 wakes up from sleep and activates the transceiver 204 and put it in receive mode. In step 502, the sensor tag tries to receive a response for a short period of time (X seconds). The timeout value X is chosen by experiment considering the trade-off between average sensor tag power consumption in idle and the likelihood it can catch a wireless command transmitted by the tag manager. If in the following step 503 the beginning of a correct tag manager command comprising a correct preamble and a matching tag manager ID is not received, in step 517 the transceiver 204 is deactivated to conserve power. If in step 503 the beginning of a correct tag manager command is received, remaining part of the tag manager command, comprising a command ID, a flag indicating if the command ID is a multiple target command, a target sensor tag ID, and optionally for multiple target command, target ID range information (minimum and maximum sensor tag ID to be targeted), is received in step 504. In the following step 505, the control circuit 203 compares the received target sensor tag ID against ID of the present sensor tag which may be stored in flash memory 201. If they are equal, the received command is carried out in step 507. Otherwise, if the command is multiple target command, in step 506, the control circuit 203 determines if the ID of the present sensor tag is within the received target ID range. If yes, in step 509 the timeout value X is increased, in order to receive for a longer period of time in step 502 anticipating packet targeting this tag will soon be received, and the control flow transitions to step 502. If the command is not multiple target command or target ID range does not include ID of the present tag, then in step 517 the transceiver 204 is deactivated to conserve power.

After carrying out non-time-consuming commands in step 507, or scheduling to execute the command later if the command is time consuming such as Flash memory write or powering on/off the magnetic sensor 205, in step 508 the sensor tag transmits using wireless transceiver 204 a response comprising the preamble, a tag manager ID, a response flag, and response data such as battery voltage or flash memory contents, then powers off transceiver 204 in step 517.

In the steady state loop of the sensor tag, the sensor tag 200 may be configured to carry out a series of actions in steps 511 to 516. These steps 511 to 516 may be executed once every N (a configurable positive integer) times the control flow passes them, thereby allowing user to configure the frequency at which these actions are executed, in order to achieve an optimum trade-off between average power consumption of the sensor tag (hence battery life) and timeliness of results. In step 516, control circuit 203 may power on the 3D digital compass (magnetic field sensor) 205 and take measurement of Earth's magnetic field with respect to the current orientation of the sensor tag. The digital compass 205 is immediately powered off after measurement in step 515 to conserve power. Because widely available 3D digital compass IC such as HMC5883L allows high resolution measurement with error less than 1 degree, any slight physical movement of the sensor tag that results in change in its orientation in any direction by as little as 1 degree can be detected, after any amount of time passed after the movement. This allows executing step 516 very infrequently to reduce average power consumption, and still be able to detect past tampering or movement. This is in contrast with systems using inertial sensors to detect movement. For these systems, the inertial sensors must take measurement at exactly the same moment the movement occurs. Since there is no prior knowledge when a movement will occur, these sensors must be running continuously instead of periodically with very a small duty cycle. This prevents these systems from being powered by a small battery and have long battery life, or by an energy harvesting unit.

In step 514, if a new measurement shows substantial change on the orientation of the sensor tag, the new measurement data are transmitted using transceiver 204 to the tag manager as a tag event. The detail of this step is discussed later in association with FIG. 7. In step 513, if a beep command is received, buzzer 202 is activated according to command data (such as duration, beep frequency, etc). If a stop-beep command is received buzzer 202 is deactivated. Alternatively, the initial beep command may include configurations to allow a change in measured magnetic field to cause the beep to stop. This is useful in the scenario where the user activates the beep in order to locate the sensor tag, upon locating the tag, the user picks up the tag, and naturally the beeping sound is no longer needed. At which time, the magnetic sensor detects tag orientation change caused by the user picking up the tag, and automatically stops the beeping sound.

In step 512 any scheduled command such as Flash memory write may be executed. In step 511, at user configured interval, the sensor tag transmits a keep-alive “ping” using transceiver 204 to the tag manager. This allows software running in Web server 105 to monitor if each sensor tag is alive or out-of-range. The detail of this step is discussed later in association with FIG. 8. Finally in step 510 the control circuit 203 is put in a sleep state for a configurable amount of time.

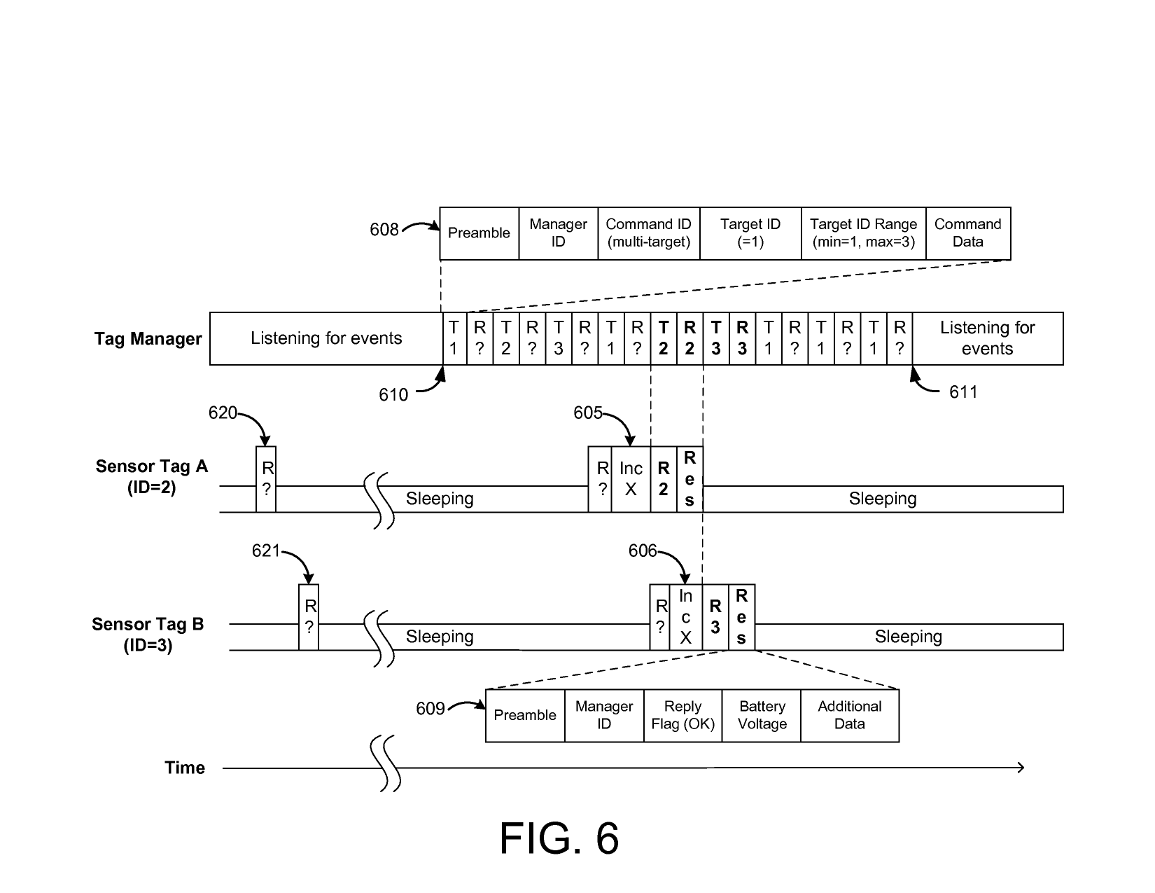

Now referring to FIG. 6, which shows a timing diagram of the present invention during a wireless communication between a tag manager and two sensor tags, before, during and after the tag manager transmits a multiple-target command targeting sensor tags with ID of 1, 2, and 3. Only sensor tags with ID of 2 and 3 are currently within range. The horizontal axis is time (not to scale), and the height of each block represents relative instantaneous power consumption. Before the instant 610, the tag manager is mostly in step 417. Blocks “R?” represent step 406 or 502, where no correct preamble and manager ID has been received before timeout. During activities 620 and 621, which last for approximately X seconds, each sensor tag consumes relatively high instantaneous power, but since this happens every Y seconds when no command is issued by the tag manager (idle state), average power consumption is reduced to approximately X/(Y+X) times (assuming during sleep power consumption is negligible). X is much smaller than Y, and since Y can be configured by user to be arbitrarily large, average sensor tag power consumption during idle state can become arbitrarily small, which is ultimately limited by sleep power consumption.

At instant 610 the tag manager receives a multiple-target command, and shortly after starts transmission. Firstly, blocks “T1” represent that the manager transmits a sequence of wireless data (“packet”) as shown in 608 comprising a preamble, a manager ID unique to the present tag manager in order to allow sensor tags to distinguish from transmissions by other tag managers with which they are not associated, a command ID with a flag indicating multiple target command, a target sensor tag ID (1 in blocks named “T1”, 2 in blocks named “T2”, and 3 in blocks named “T3”), and target ID range information (minimum ID is 1, maximum ID is 3). As shown in FIG. 6, the tag manager cycles through each target ID, but sends out the target ID range information in every packet. No response will be received by the tag manager until activity 605 when Tag A is scheduled to wake up from sleep. During activity 605, Tag A first receives a transmission from a block “T1”. Its target ID does not match with Tag A's ID, but Tag A's ID falls within the target range. Therefore, step 509 is executed and X is increased. Soon a transmission from block “T2” with a matching target ID is received, and Tag A transmits a response in step 508. As a coincidence, (in activity 606) Tag B wakes up shortly after Tag A wakes up, and receives transmission from the same block “T2”. If the tag manager were to simply include all target IDs in a multi-target command, Both Tag B and Tag A would have transmitted a response in step 508 at exactly the same time. This would have caused interference on the air and no valid response would be received by the tag manager. Instead, the present invention provides the tag manager to cycle through each target ID as shown in FIG. 6. This method effectively avoids any such possible interference, so response from each tag can be received in an orderly manner. At instant 611, the command timeout (Z seconds in step 410) occurs, and the tag manager stops transmission. The timeout is necessary not only to allow tag manager to resume listening for events from other sensor tags, but also to satisfy FCC rules on maximum duration of continuous transmission in the 433 MHz band by unlicensed users.

FIG. 7 depicts a preferred control flow chart used by the embodiment of a sensor tag shown in FIG. 2, with more details for steps 514, 515 and 516. Steps 702, 703, 704 corresponds to steps 501 to 509 and 517. After powering off transceiver 204 in step 704 (or 517), in step 705 the control circuit 203 determines if the motion sensor tag is in armed state. If true, in step 706 the control circuit decrements an interval counter. In the following step 707, it determines if the interval counter has reached 0. If true, in step 708 it resets the interval counter to a value configured by the user previously. In the following step 709 and 710, it powers on the magnetic sensor 205, takes a measurement of 3D direction of the Earth's magnetic field with respect to the orientation of the sensor tag, and powers off the sensor 205 immediately after the measurement. In the following step 711, the control circuit 203 calculates the difference between the latest measurement results and the measurement results from one before, and determines if they differ by more than a user configured threshold. If true, in step 712 a retry counter is reset to a value configured by user in preparation for transmission of the updated measurement results. In the next step 721, transceiver 204 is activated, and in step 720, a packet comprising the preamble, a tag manager ID with which the sensor tag is associated, the ID of the present sensor tag, an event type indicating that the packet contains updated magnetic sensor reading, and the actual reading data are transmitted. Immediately in step 719, the transceiver 204 is put in receive mode and try to receive a valid response from the tag manager comprising a correct preamble and matching manager ID, or until a timeout. After step 719, the transceiver 204 may be deactivated in step 718 to conserve power. If in step 717 no valid response is received, control circuit 203 determines in step 715 if the retry counter has reached 0. If it has not reached 0, in step 714 the retry counter is decremented. In the following step 713 the control circuit 203 waits for a small amount of time which may be user configurable. If the wireless communication in step 720 or 719 failed because of temporary interference, then after the wait in step 713, the interference is likely to have gone away. If the retry counter has reached 0, in step 716 the sensor tag disarms itself by setting armed flag to 0. At this stage, it is highly likely that either the tag manager has been powered off, or the tag has been moved completely out of range from the tag manager. By disarming itself, likely futile future transmission and repeated re-transmission of sensor events is avoided to conserve battery power. At this step 716, the sensor tag may optionally emit a sound through buzzer 202 indicating to the user that it has disarmed itself because of lost link with the tag manager.

FIG. 8 depicts a preferred control flow chart used by the embodiment of a sensor tag shown in FIG. 2, with more details for step 511. Steps 802, 803, 804 corresponds to steps 501 to 509 and 517. After powering off transceiver 204 in step 804 (or 517), in step 805 the control circuit 203 determines if the tag is configured to periodically transmit (“post-back”) a keep-alive “ping” packet. If true, in step 806 it decrements a post-back interval counter. In the following step 807, it determines if the post-back interval counter has reached 0. If true, in step 808 it resets the post-back interval counter to a value configured by the user previously. In the following step 809 a retry counter is reset to a value configured by user in preparation for transmission of the “ping” packet. In the next step 810, transceiver 204 is activated, and in step 811, a packet comprising the preamble, a tag manager ID with which the sensor tag is associated, the ID of the present sensor tag and an event type indicating that the packet is a keep-alive “ping” packet, is transmitted. Immediately in step 812, the transceiver 204 is put in receive mode and try to receive a valid response from the tag manager comprising a correct preamble and matching manager ID, or until a timeout. After step 812, the transceiver 204 may be deactivated in step 813 to conserve power. If in step 814 no valid response is received, control circuit 203 determines in step 817 if the retry counter has reached 0. If it has not reached 0, in step 816 the retry counter is decremented. In the following step 815 the control circuit 203 waits for a small amount of time which may be user configurable. If the wireless communication in step 811 or 812 failed because of temporary interference, then after the wait in step 815, the interference is likely to have gone away. If the retry counter has reached 0, in step 818 the sensor tag configures itself to stop future “post-back”. At this stage, it is highly likely that either the tag manager has been powered off or the tag has been moved completely out of range from the tag manager. By stopping future “post-back”, likely futile future transmission and repeated re-transmission are avoided to conserve battery power. At this step 818, the sensor tag may optionally emit a sound through buzzer 202 indicating to the user that it has lost link with the tag manager.

FIG. 9 depicts a preferred control flow chart used by the embodiment of a tag manager shown in FIG. 3, illustrating in more detail the initial start-up sequence and the interaction among the tag manager, the Web Server and the Chat Server. Steps 920, 921 and 922 are executed by the Web server while the rest of the steps are executed by the tag manager. In step 901, the tag manager 300 is first powered up by the user by plugging in power cable or by a hardware reset. The tag manager in step 902 acquires a new IP address from the network using DHCP, but other types of IP address configuration schemes or static IP address stored in firmware may also be employed in step 902. In the following step 903, the tag manager calls a Login web service method provided by the Web Server 105. In step 904, the tag manager receives from Web server 105, as return results of the Login web service method, information about the Chat Server 104 including IP address and port number, and a unique nickname for the present tag manager to use when connecting to the Chat Server 104. In step 920 which is triggered by step 903, the Web server stores the nickname and Chat Server information in a database to be used later for issuing commands to the tag manager as chat messages through the Chat Server. After step 904, the tag manager tries to connect to Chat Server 104 by using the information received. If connection is not successful in step 906, the tag manager may call the same Login web service method or other web service method on the Web server 105 depending on the type of error it received while connecting to the Chat Server. For example, if there was a nickname conflict, the Web Server generates a new nickname and returns to the tag manager. The tag manager then retries connection to the Chat Server in step 905. If connection to Chat Server is successful, in step 907 the tag manager waits for a chat message. Step 907 corresponds to step 401, and step 908 abbreviates step 402 to 411. If in step 909 a PING is received from Chat Server 104, in step 911 the tag manager calls a Ping web service method provided by the Web Server 105. Triggered by step 911, in step 922 the Web Server stores the time at which the Ping web method is called for the present tag manager, and compares it with the last time the Ping web method was called for that tag manager. If too much time has passed, step 921 is triggered. Step 921 is also triggered shortly after step 920. In step 921, it is assumed that the present tag manager has been out of service (power is lost, Internet connection has lost etc.) and has just returned to service. This means while the tag manager has been out of service, some sensor tags may have disarmed themselves in step 716 or configured themselves to not to “post-back” in step 818. Whether each sensor tag has been armed, and whether each sensor tag has been configured to “post-back” have been stored in a database accessed by the Web Server 105. The Web Server 105 records all these information about every sensor tag as every user action and configuration command goes through Web Server 105. Using these information, in step 921 the Web Server issues a series of commands to the tag manager to restore each Tag's states according to the database. Specifically, for each tag in armed state, a command to re-arm is issued. For each tag configured to “post-back” at certain interval, a command to set the post-back interval is issued. Finally in step 910, in the event when the TCP/IP connection to the Chat Server 104 is lost, control flow is redirected to step 903, such that the Web server can direct the tag manager to connect to another Chat Server that is available. By a “soft-reset” configuration command issued by Web server 105 to the tag manager, the control flow may also be redirected to step 903, such that any particular tag manager may be redirected to a different Chat Server for system maintenance reasons. These methods allow the system in the present invention to maximize availability and robustness against temporary failure of parts of the system.

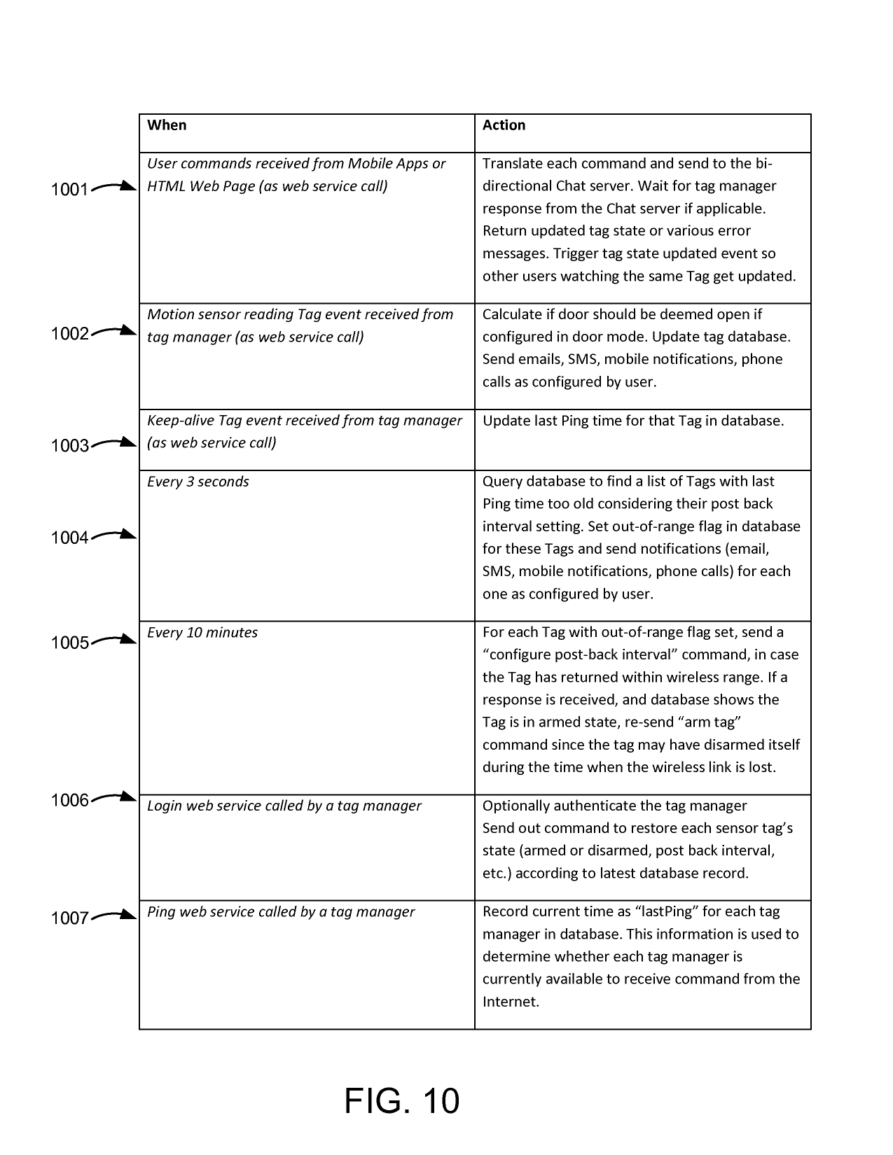

FIG. 10 shows a table summarizing operation performed by the Web Server 105. A Web server is an event driven system which performs certain actions on certain events, including receiving a web service method call from a client, and timer time-out. When clients 108, 109, 110, and 111 operated by end user interact with the system show in FIG. 1 in the present invention, it is in the form of a web service method call to Web Server 105. Triggered by such events 1001, the Web server 105 translates each user command and send it to the bi-directional Chat Server. Server 105 waits for a tag manager response from the Chat Server if one is expected for that particular type of command. Server 105 updates database with new tag states and returns updated tag states or various error messages to the clients. The server may also trigger a tag-state-updated event so every client subscribing to events associated with the present tag manager gets updated.

Each tag manager 101 also calls web service methods on Web Server 105. The events 1002 and 1003 happen when a tag manager receives a Tag event through transceiver 204 and calls the Web server in step 413. In 1002, the Tag event is for updated magnetic sensor reading, and the Web server handles this by calculating if door should be deemed open if the sensor tag is configured in a door mode. The Web Server 105 also updates the database 120 to store the reading, date and time or other information. As configured by user, the Web Server 105 may also send emails, SMS or phone calls (preferably by calling web services on servers 107), and/or mobile notifications (preferably by calling web services on servers 112 or 106), to notify users. In 1003, the Tag event is keep-alive “ping”, and the Web server handles this by updating a “last Ping time” for that Tag in database 120.

A timer keeps running at the Web Server and fires event 1004 every 3 seconds or at a similarly short interval. On this event 1004, the Web Server queries the database to find those Tags with “last Ping time” too old taking into account their post-back interval setting in database 120, then sets an out-of-range flag in database 120, and then sends notifications (email, SMS, mobile notifications, phone calls) as configured by user. Another timer keeps running at the Web server and fires event 1005 every 10 minutes or at an interval in the same order. On this event 1005, for each Tag with out-of-range flag set in the database 120, the Web server send a “configure post-back interval” command, in case that the Tag has returned within range. If a response is received, and database shows the Tag is in armed state, the Web Server also re-sends an “arm tag” command since the tag may have disarmed itself during the time when the wireless link was lost.

Actions to handle event 1006 are as described in step 921 in association with FIG. 9. The tag manager may periodically call a “Ping” web service method on the Web Server 105. On this event 1007, the Web Server may record current time as “lastPing” for each tag manager in the database 120. This information may be used to quickly determine whether each tag manager is currently available or not, without actually trying sending a command to each tag manager. For example, if it is known that each tag manager will call the Ping web service method every 5 minutes, a database query to find all those tag managers with lastPing older than 5 minutes would return a list of tag managers that may be currently unavailable.

I claim:

1. A system for allowing users to monitor and receive notification through the Internet on movement of physical items comprising, one tag manager, one or more sensor tags, and one or more Internet servers, wherein said tag manager is wirelessly coupled to each one of said sensor tags, and said tag manager being capable of connecting to the Internet, wherein said tag manager comprising:
a first control circuit;
a memory device coupled to said first control circuit for storing identification information;
a first wireless transceiver circuit coupled to said first control circuit for initiating wireless transmission to and receiving response from each one of said sensor tags;
a means to receive wireless transmission from each one of said sensor tags;
a transceiver circuit for connecting to the Internet; and
said sensor tag comprising:
a second control circuit;
a second wireless transceiver circuit coupled to said second control circuit for sending and receiving wireless transmission to and from said tag manager;
a memory device coupled to said second control circuit for storing identification information;
a sensor device for detecting movement;
a means to transmit readings of said sensor device to said tag manager;
and a means for timing control coupled to said second control circuit for periodically activating for a short period of time and then de-activating said wireless signal transceiver circuit and said sensor device, thereby significantly reducing average power consumption of said sensor tag to allow a long battery life.

2. The system of claim 1, wherein said sensor tag is powered by a rechargeable battery, and further includes:
a solar panel coupled to a solar battery charger circuit, said solar battery charger circuit being capable of extracting electrical energy from said solar panel when available and charging said rechargeable battery, and providing a stable supply voltage for powering said second control circuit, said second wireless transceiver and said sensor device.

3. The system of claim 1, wherein said Internet servers comprise one or more Web servers comprising:
a means to receive an event from said tag manager and;
a means to notify users as a result of said event received from said tag manager, by one selected from the group consisting of making a phone call, sending a text message, sending a Push Notification Message, sending a Cloud to Device Message, and sending an email message.

4. The system of claim 1, wherein said sensor device for detecting movement comprises a multi-dimensional magnetic sensor with sufficient sensitivity to measure the magnetic field of the Earth.

5. The system of claim 1, wherein said sensor device for detecting movement comprises an acceleration sensor with sufficient sensitivity to measure the gravitational pull of the Earth.

6. The system of claim 1, wherein said means to transmit readings of said sensor device further includes a means to try receiving an acknowledgement from said tag manager, and if said acknowledgement is not successfully received, to repeat transmission of said readings until said acknowledgement is successfully received, or the number of transmission exceeds a predetermined value.

7. The system of claim 1, wherein said sensor tag further includes a means to periodically transmit a ping packet to said tag manager, and a means to try receiving acknowledgement from said tag manager in response to said ping packet, and if said acknowledgement is not successfully received, to repeat transmission of said ping packet until said acknowledgement is successfully received, or the number of transmission exceeds a predetermined value.

8. The system of claim 1, wherein said sensor tag further includes an audible signal generator circuit coupled to said second control circuit for generating audible signals upon activation by said second control circuit in response to a command from said web server, whereby helping user locating said sensor tags that are within audible distance from the user.

9. The system of claim 8, wherein said second control circuit further includes a means to automatically stop generating audible signals when said sensor device detects movement.

10. The system of claim 1, wherein said tag manager and said sensor tag further include a plurality of non-volatile memory device to store identification information to prevent said information from being lost when power supply is absent.

11. A method for allowing users to monitor and receive notification through the Internet on movement of physical items comprising the steps of:
periodically powering-on a sensor device selected from the group consisting of magnetic sensor and acceleration sensor, and taking a measurement by using said sensor device;
periodically powering-off said sensor device, thereby significantly reducing average power consumption to allow a long battery life;
when a new result from said measurement is substantially different from a result from a previous measurement, activating a first wireless transceiver to transmit a data packet containing said new result;
activating a second wireless transceiver to receive said data packet; and
when said data packet has been received, sending first information contained in said data packet to an Internet server.

12. A method in accordance with claim 11 and comprising the additional step of
After receiving said first information, sending notifications through the Internet to an end user by one selected from the group consisting of making a phone call, sending a text message, sending a Push Notification Message, sending a Cloud to Device Message, and sending an email message.

13. A method in accordance with claim 11 and comprising the additional steps of
harvesting solar energy when said solar energy is available, and using harvested energy to charge a rechargeable battery and to provide power supply to said sensor device and said first wireless transceiver; and
when said solar energy is insufficient, providing power supply to said sensor device and said first wireless transceiver from said rechargeable battery to allow said sensor device and said first wireless transceiver to continue to function.

14. A method in accordance with claim 11 and comprising the additional steps of
activating said second wireless transceiver in transmit mode in order to transmit a first acknowledgement after receiving said data packet;
activating said first wireless transceiver in receive mode in order to receive a first acknowledgement after transmitting said data packet; and
when said first acknowledgement is not received, repeating transmission of said data packet until an acknowledgement is successfully received, or the number of transmission exceeds a predetermined value.

15. A method in accordance with claim 11 and comprising the additional steps of
periodically activating said first wireless transceiver in transmit mode in order to transmit a ping packet which contains identification information identifying said first wireless transceiver;
activating said second wireless transceiver in receive mode in order to receive said ping packet;
activating said second wireless transceiver in transmit mode in order to transmit a second acknowledgement after receiving said ping packet;
activating said first wireless transceiver in receive mode in order to receive said second acknowledgement after transmitting said ping packet; and
when said second acknowledgement is not received, repeating transmission of said ping packet until an acknowledgement is successfully received, or the number of transmission exceeds a predetermined value;
when said ping packet has been received, sending said identification information contained in said ping packet to an Internet server; and
storing said identification information and current time in a database that is accessed by said Internet server.

16. A method in accordance with claim 15 and comprising the additional steps of
periodically retrieving said identification information and time from said database;
calculating difference between retrieved time and current time;
if the difference is larger than a predetermined threshold, sending notification messages to an end user, through the Internet by one selected from the group consisting of making a phone call, sending a text message, sending a Push Notification Message, sending a Cloud to Device Message, and sending an email message.

17. A method in accordance with claim 15 and comprising the additional steps of
periodically retrieving said identification information and time from said database;
calculating difference between retrieved time and current time;
if the difference is larger than a predetermined threshold, marking each one of said first wireless transceiver identified by first said identification information in said database;
periodically sending a wireless transmission targeting each marked wireless transceiver; and if a response to said wireless transmission is received, unmarking said targeted wireless transceiver in said database.
